(19) United States
(12) Patent Application Publication
(10) Pub. No.: US 2025/0232529 A1
(43) Pub. Date: Jul. 17, 2025

(54) VIRTUAL ELEMENT DISPLAY

(71) Applicant: Tencent Technology (Shenzhen) Company Limited, Shenzhen (CN)

(72) Inventor: Zhidong WANG, Shenzhen (CN)

(73) Assignee: Tencent Technology (Shenzhen) Company Limited, Shenzhen, GD (CN)

(21) Appl. No.: 19/171,147

(22) Filed: Apr. 4, 2025

Related U.S. Application Data
(63) Continuation of application No. PCT/CN2023/130353, filed on Nov. 8, 2023.

(30) Foreign Application Priority Data
Feb. 23, 2023 (CN) 202310203196.3

(51) Int. Cl. G06T 17/00; A63F 13/69

(52) U.S. Cl. CPC G06T 17/00; A63F 13/69

(57) ABSTRACT

In an element display method, first position information and field of view information of a main control virtual character in a virtual scene are acquired. The field of view information indicates a field of view range of the main control virtual character within the virtual scene. Second position information of a virtual element in the virtual scene is acquired. A scene distance between the first position information and the second position information in the virtual scene is determined. A level of importance of the virtual element is determined based on the scene distance and whether the virtual element is within or outside the field of view range that is indicated by the field of view information. A display performance parameter for the virtual element is determined based on the level of importance. Display control of the virtual element is performed based on the display performance parameter.

### RELATED APPLICATIONS

The present application is a continuation of International Application No. PCT/CN2023/130353, filed on Nov. 8, 2023, which claims priority to Chinese Patent Application No. 202310203196.3, filed on Feb. 23, 2023. The entire disclosures of the prior applications are hereby incorporated reference.

### FIELD OF THE TECHNOLOGY

This application relates to the field of computer technologies, including an element display method.

### BACKGROUND OF THE DISCLOSURE

With the development of computer technologies and networks, realism and richness of games are significantly improved. Most games provide simulated virtual scenes. These virtual scenes include a large number and a wide variety of virtual elements such as a sky, a lawn, a vehicle, a monster, and the like.

In related art, during development of this type of game, a virtual engine may be used for rendering a virtual element in real time, thereby enabling a rendered virtual scene to be displayed on a terminal interface in real time.

However, when the virtual scene contains a large number of complex elements, rendering the virtual elements at the same time consumes considerable computing resources of a computer, and degrades performance of a processor in the computer.

### SUMMARY

Aspects of this disclosure include an element display method, an apparatus, and a non-transitory computer-readable storage medium to optimize performance of a processor in a computer while rendering an element in a virtual scene. Examples of technical solutions of this disclosure may be implemented as follows:

An aspect of this disclosure provides an element display method. First position information and field of view information of a main control virtual character in a virtual scene are acquired. The field of view information indicates a field of view range of the main control virtual character within the virtual scene. Second position information of a virtual element in the virtual scene is acquired. A scene distance between the first position information and the second position information in the virtual scene is determined. A level of importance of the virtual element is determined based on the scene distance and whether the virtual element is within or outside the field of view range that is indicated by the field of view information. A display performance parameter for the virtual element is determined based on the level of importance. Display control of the virtual element is performed based on the display performance parameter. The display performance parameter corresponds to a presentation effect of the virtual element in the virtual scene.

An aspect of this disclosure provides an apparatus. The apparatus includes processing circuitry configured to acquire first position information and field of view information of a main control virtual character in a virtual scene. The field of view information indicates a field of view range of the main control virtual character within the virtual scene. The processing circuitry is configured to acquire second position information of a virtual element in the virtual scene. The processing circuitry is configured to determine a scene distance between the first position information and the second position information in the virtual scene. The processing circuitry is configured to determine a level of importance of the virtual element based on the scene distance and whether the virtual element is within or outside the field of view range that is indicated by the field of view information. The processing circuitry is configured to determine a display performance parameter for the virtual element based on the level of importance. The processing circuitry is configured to perform display control of the virtual element based on the display performance parameter. The display performance parameter corresponds to a presentation effect of the virtual element in the virtual scene.

An aspect of this disclosure provides a non-transitory computer-readable storage medium storing instructions which when executed by a processor cause the processor to perform any of the methods of this disclosure.

The technical solutions provided in this disclosure can include the following beneficial effects:

The level of importance of the virtual element is determined by determining the scene distance between the first position information of the main control virtual character and the second position information of the virtual element in the virtual scene, and the field of view information corresponding to the main control virtual character, whereby the display performance data for the virtual element is determined, and display control is performed on the virtual element based on the display performance data. On one hand, differentiated display of virtual elements in a virtual scene is implemented based on levels of importance, and computing resources of a computer are properly allocated, whereby performance of a processor in the computer is optimized while normal display of the virtual scene is ensured. On the other hand, the level of importance is determined based on dual conditions of a position and a field of view, whereby a granularity of an importance criteria is improved. Accordingly, finally obtained display performance data is more accurate, and an optimization rate of the display performance of the computer is improved.

### BRIEF DESCRIPTION OF THE DRAWINGS

FIG. 1 is a schematic diagram of an implementation environment according to an aspect of this disclosure.

FIG. 2 is a flowchart of an element display method according to an aspect of this disclosure.

FIG. 3 is a schematic diagram of rating of a level of importance according to an aspect of this disclosure.

FIG. 4 is a flowchart of an element display method according to another aspect of this disclosure.

FIG. 5 is a flowchart of an element display method according to a yet another aspect of this disclosure.

FIG. 6 is a flowchart of registration for important rating according to an aspect of this disclosure.

FIG. 7 is a flowchart of importance rating according to an aspect of this disclosure.

FIG. 8 is a schematic diagram of a presentation of a virtual element subjected to rating by an importance system according to an aspect of this disclosure.

FIG. 9 is a structural block diagram of an element display apparatus according to an aspect of this disclosure.

FIG. 10 is a structural block diagram of a computer device according to an aspect of this disclosure.

### DETAILED DESCRIPTION

Aspects of this disclosure provide an element display method, which is applicable to applications with virtual scenes, such as first-person shooting games, third-personal shooting games, multiplayer online battle arena games, and massive multiplayer online role-playing games. In an importance rating-optimization solution provided in the aspects of this disclosure, a level of importance of an element in a scene is determined based on a distance between a character and the element in the scene, as well as an inclusion relationship between the element and a field of view of the character, whereby optimizable display performance data in a system is optimized based on the level of importance, and differentiated display of elements in the scene is implemented, computing resources in a computer are properly allocated, and the performance of a processor in the computer is optimized while the normal display of the virtual scene is ensured. Further, the descriptions of the terms are provided as examples only and are not intended to limit the scope of the disclosure.

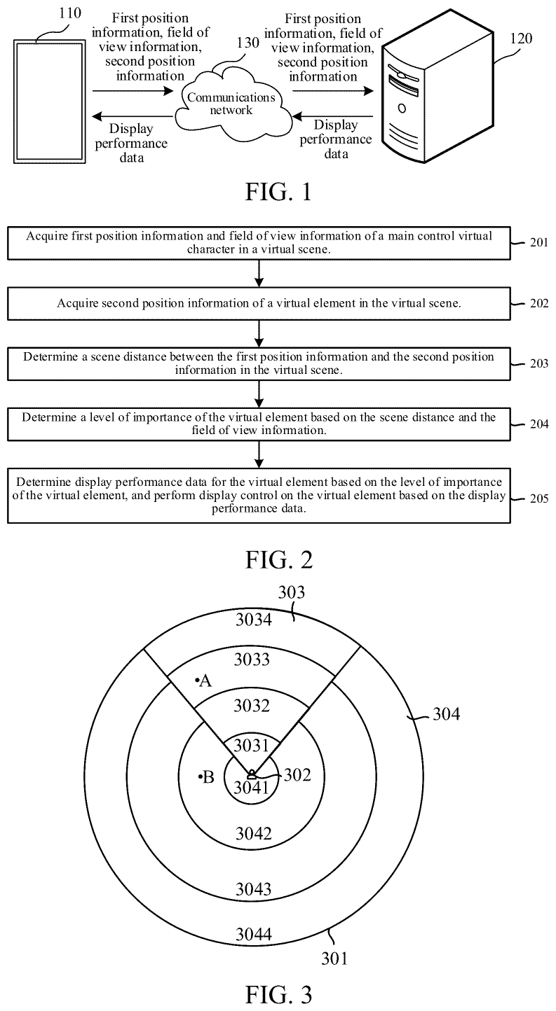

FIG. 1 is a schematic diagram of an implementation environment according to an aspect of this disclosure. As shown in FIG. 1, the implementation environment involves a terminal 110 and a server 120. The terminal 110 and the server 120 are connected through a communications network 130. The communications network 130 may be a wired or wireless network. This is not limited in this aspect of this disclosure.

In some aspects, a target application supporting a virtual scene is installed and run in the terminal 110. The target application may be any one of a virtual reality (VR) application, a first-person shooting (FPS) game, a third-personal shooting (TPS) game, a multiplayer online battle arena (MOBA) game, and a massive multiplayer online role-playing game (MMORPG). This is not limited in this aspect of this disclosure.

In some aspects, the server 120 is configured to provide a backend service for the target application installed in the terminal 110. In an example, the target application installed in the terminal 110 is logged in with a first account corresponding to a main control virtual character. When the target application runs, the virtual scene of the target application is displayed in the terminal 110, and the terminal 110 controls the main control virtual character. When an element in the virtual scene displayed in the terminal 110 is required to be displayed, the server 120 acquires first position information and field of view information of the main control virtual character in the virtual scene, and acquires second position information of a plurality of virtual elements in the virtual scene. Then, the server 120 determines a scene distance between the first position information and the second position information in the virtual scene, and determines a level of importance of the virtual element based on the scene distance and the field of view information. Finally, the server 120 determines display performance data for the virtual element according to the level of importance of the virtual element, and performs display control on the virtual element based on the display performance data. In some aspects, the server 120 transmits the display performance data to the terminal 110. After receiving the display performance data, the terminal 110 renders and displays the virtual element according to the display performance data. Therefore, the server 120 performs differentiated display on the virtual elements in the virtual scene from the perspective of optimizing performance of a processor, to maximum an efficiency of the processor.

The terminal 110 is at least one of a smartphone, a tablet computer, a notebook computer, a desktop computer, a smart speaker, a smart wearable device, a smart voice interaction device, a smart household appliance, an on-board terminal, and the like.

The server 120 may be an independent physical server, or may be a server cluster or distributed system composed of a plurality of physical servers, or may be a cloud server that provides basic cloud computing services such as a cloud service, a cloud database, cloud computing, a cloud function, cloud storage, a network service, cloud communication, a middleware service, a domain name service, a security service, a content delivery network (CDN), a big data platform, and an artificial intelligence (AI) platform.

Cloud technology is a hosting technology that unifies a series of resources such as hardware, software, and a network in a wide area network or a local area network, to implement data computing, storage, processing, and sharing. The cloud technology is a generic term for a network technology, an information technology, an integration technology, a management platform technology, an application technology, and the like applied based on a cloud computing commercial mode, and may form a pool of resources, which is used on demand and is flexible and convenient. A cloud computing technology is to become an important support. Backend services of a technology network system require a huge amount of computing and storage resources, such as video websites, image websites, and more portal websites. With the high-level development and application of the Internet industry, every item may have its own identification mark in the future, which needs to be transmitted to a backend system for logical processing. Data at different levels may be processed separately, and various types of industry data require strong system back support, which can only be implemented through cloud computing. In an aspect, the server 120 is alternatively implemented as a node in a blockchain system.

One or more modules, submodules, and/or units of the apparatus can be implemented by processing circuitry, software, or a combination thereof, for example. The term module (and other similar terms such as unit, submodule, etc.) in this disclosure may refer to a software module, a hardware module, or a combination thereof. A software module (e.g., computer program) may be developed using a computer programming language and stored in memory or non-transitory computer-readable medium. The software module stored in the memory or medium is executable by a processor to thereby cause the processor to perform the operations of the module. A hardware module may be implemented using processing circuitry, including at least one processor and/or memory. Each hardware module can be implemented using one or more processors (or processors and memory). Likewise, a processor (or processors and memory) can be used to implement one or more hardware modules. Moreover, each module can be part of an overall module that includes the functionalities of the module. Modules can be combined, integrated, separated, and/or duplicated to support various applications. Also, a function being performed at a particular module can be performed at one or more other modules and/or by one or more other devices instead of or in addition to the function performed at the particular module. Further, modules can be implemented across multiple devices and/or other components local or remote to one another. Additionally, modules can be moved from one device and added to another device, and/or can be included in both devices.

The use of “at least one of” or “one of” in the disclosure is intended to include any one or a combination of the recited elements. For example, references to at least one of A, B, or C; at least one of A, B, and C; at least one of A, B, and/or C; and at least one of A to C are intended to include only A, only B, only C or any combination thereof. References to one of A or B and one of A and B are intended to include A or B or (A and B). The use of “one of” does not preclude any combination of the recited elements when applicable, such as when the elements are not mutually exclusive.

According to the above description and implementation environment, FIG. 2 is a flowchart of an element display method according to an aspect of this disclosure. The method may be performed by a server or a terminal, or may be jointly performed by a server and a terminal. In this aspect of this disclosure, a description is made by using an example in which the method is performed by a server. As shown in FIG. 2, the method includes the following operations.

Operation 201: Acquire first position information and field of view information of a main control virtual character in a virtual scene. For example, first position information and field of view information of a main control virtual character in a virtual scene are acquired. The field of view information indicates a field of view range of the main control virtual character within the virtual scene.

In an aspect, the virtual scene includes at least one of a two-dimensional virtual scene, a 2.5-dimensional virtual scene, a three-dimensional virtual scene, and the like. The virtual scene includes at least one of a virtual sky, a virtual land, a virtual ocean, and the like. This is not limited in this aspect of this disclosure.

The main control virtual character may refer to a virtual object controlled by a specified account, and the virtual scene is a scene displayed when a specified application logged into with the specified account runs in a terminal. The specified application includes any one of an FPS game, a TPS game, an MOBA game, a MMORPG, and the like. This is not limited in this aspect of this disclosure.

In an example, a target game is installed and run in a first terminal, and a first account is logged into the target game. That is, a main control virtual character controlled by the first account and other display elements are displayed in a virtual game scene provided by the target game. In this aspect of this disclosure, if the server needs to rate importance of each element in the virtual game scene corresponding to the first account, the server first acquires the first position information and the field of view information of the main control virtual character controlled by the first account.

In an aspect, the first position information includes a current coordinate location of the main control virtual character in the virtual scene. For example, the virtual scene corresponds to a world coordinate system, and coordinates of the main control virtual character in the world coordinate system are the first position information.

The field of view information indicates a field of view range for observing the virtual scene from a perspective of the main control virtual character. The perspective of the main control virtual character may be a first-person perspective or a third-person perspective. This is not limited in this aspect of this disclosure. For example, a field of view range corresponding to a first virtual character controlled by the first account is represented as a range of a virtual scene that corresponds to the first account and that is displayed on a screen of the terminal, namely, a range of a window from which a player observes the virtual scene.

Operation 202: Acquire second position information of a virtual element in the virtual scene. For example, second position information of a virtual element in the virtual scene is acquired.

In an aspect, the virtual element may refer to a display element other than the main control virtual character in the virtual scene. The virtual element includes at least one of the following elements:

1. A character-type virtual element.

In an aspect, the character-type virtual element includes a virtual monster, a non-player character (NPC), a virtual object controlled by another account other than the main control virtual character, and the like.

2. A scene-type virtual element.

For example, the scene-type virtual element may refer to an environment element forming a virtual scene, and includes a natural landform element, a building element, and the like.

3. A prop-type virtual element.

For example, the prop-type virtual element includes a virtual vehicle, a virtual attack prop, a virtual defense prop, a virtual gemstone, a virtual gold coin, and the like.

The foregoing examples of the virtual element are merely for description, and the element type of the virtual element is not limited in this aspect of this disclosure.

In an aspect, the second position information includes a current coordinate location of the virtual element in the virtual scene. For example, coordinates of the virtual element in the world coordinate system are the second position information.

Operation 203: Determine a scene distance between the first position information and the second position information in the virtual scene. For example, a scene distance between the first position information and the second position information in the virtual scene is determined.

That is, a distance between the main control virtual character and the virtual element in the virtual scene is determined.

For example, a first coordinate of the main control virtual character in the world coordinate system is acquired, and a second coordinate of the virtual element in the world coordinate system is acquired. A coordinate distance between the first coordinate and the second coordinate is calculated. The coordinate distance is the distance between the main control virtual character and the virtual element, i.e., the scene distance.

In an aspect, there may be one or more virtual elements. If there are a plurality of virtual elements in the virtual scene, the server needs to acquire second position information of each virtual element, and separately calculate a scene distance between each piece of second position information and the first position information in the virtual scene.

Operation 204: Determine a level of importance of the virtual element based on the scene distance and the field of view information. For example, a level of importance of the virtual element is determined based on the scene distance and whether the virtual element is within or outside the field of view range that is indicated by the field of view information.

The level of importance indicates importance of the virtual element in the virtual scene to the main control virtual character.

The level of importance of the virtual element indicates importance of the virtual element in a current virtual scene to the main control virtual character. In this aspect of this disclosure, the level of importance of the virtual element is determined based on dual conditions of the scene distance and the field of view information.

In an aspect, a higher level of importance of the virtual element indicates higher importance of the virtual element to the main control virtual character, alternatively, a lower level of importance of the virtual element indicates lower importance of the virtual element to the main control virtual character.

In an aspect, the importance is reflected in the following several aspects:

1. Correlation to the field of view range of the main control virtual object. For example, a closer distance to the main control virtual object within the field of view range of the main control virtual object indicates higher importance, while a farther distance indicates lower importance.

2. Correlation to an interaction process. For example, during the interaction of the main control virtual object in the virtual scene, the entire interaction process lasts for 10 minutes. Among these, importance is highest from the third minute to the eighth minute in the interaction process, second highest from the first minute to the second minute, and lowest from the ninth minute to the tenth minute.

In some aspects, the level of importance of the virtual element is obtained by rating inclusion of the virtual element based on the field of view range in at least one of at least two rating manners.

In an aspect, in a case that the virtual element is within the field of view range, the importance of the virtual element is rated in a first rating manner based on the scene distance, to determine the level of importance of the virtual element; and in a case that the virtual element is outside the field of view range, the importance of the virtual element is rated in a second rating manner based on the scene distance, to determine the level of importance of the virtual element.

Distance ranges respectively corresponding to the first rating manner and the second rating manner are determined based on the distance between the virtual element and the main control virtual character, and a distance span corresponding to the distance range for the level of importance in the first rating manner is greater than a distance span corresponding to the distance range for the level of importance in the second rating manner.

For example, levels of importance corresponding to the first rating manner are level 1, level 2, and level 3, and distance ranges (distances within the ranges are distances between the virtual element and the main control virtual character) respectively corresponding to the levels of importance are (0, 20], (20, 40], and (40, 60]. Levels of importance corresponding to the second rating manner are level 1, level 2, and level 3, and distance ranges respectively corresponding to the levels of importance are (0, 10], (10, 20], and (20, 30].

In an aspect, a distance span corresponding to at least one level of importance in the first rating manner is greater than a distance span corresponding to at least one level of importance in the second rating manner.

In some aspects, in the first rating manner and the second rating manner, the scene distance is in a negative correlation with the importance, indicated by the level of importance, of the virtual element to the main control virtual character. That is, a shorter scene distance indicates a higher importance of the virtual element to the main control virtual character. In other words, regardless of being in or out of the field of view, the level of importance of the virtual element closer to the main control virtual character is higher.

In an aspect, in a case that the level of importance of the virtual element is higher and the importance of the virtual element to the main control virtual character is higher, the level of importance obtained by rating the virtual element in the first rating manner is greater than the level of importance obtained by rating the virtual element in the second rating manner. That is, the importance of all virtual elements in the field of view to the main control virtual character is greater than the importance of any virtual element out of the field of view to the main control virtual character.

For example, referring to FIG. 3, a description is made by using an example in which a higher level of importance of a virtual element indicates higher importance of the virtual element to a main control virtual character. FIG. 3 is a schematic diagram of rating of a level of importance. As shown in FIG. 3, a circular region 301 represents a virtual scene corresponding to a main control virtual character 302, a sectoral region 303 represents an in-view region corresponding to the main control virtual character 302, and a sectoral region 304 represents an out-of-view region corresponding to the main control virtual character 302. Levels of importance in the sectoral region 303 are as follows: a region 3031>a region 3032>a region 3033>a region 3034, and levels of importance in the sectoral region 304 are as follows: a region 3041>a region 3042>a region 3043>a region 3044. In addition, all levels of importance in the region 3034 are greater than any one of the levels of importance in the region 3041. For example, if a virtual element A is in the sectoral region 303, and a virtual element B is in the sectoral region 304, a level of importance of the virtual element A is greater than a level of importance of the virtual element B.

In an aspect, in a case that the level of importance the virtual element is higher and the importance of the virtual element to the main control virtual character is higher, under the condition of same scene distances, the level of importance obtained by rating the virtual element in the first rating manner is greater than the level of importance obtained by rating the virtual element in the second rating manner.

For example, if the virtual element A is in a field of view, the virtual element B is out of the field of view, and a distance between the virtual element A and the main control virtual character, and a distance between the virtual element B and the main control virtual character are the same, the level of importance of the virtual element A is greater than the level of importance of the virtual element B.

In some aspects, whether the field of view range includes the virtual element is determined by using a method of determining whether an intersection exists between an element boundary corresponding to the virtual element and the field of view range. The operation for determining a level of importance of the virtual element based on the scene distance and the field of view information further includes:
an element boundary corresponding to the virtual element is determined according to the second position information; in a case that an intersection exists between the element boundary and the field of view range, the importance of the virtual element is rated in a first rating manner based on the scene distance, to determine the level of importance of the virtual element; and in a case that the element boundary does not have an intersection with the field of view range, the importance of the virtual element is rated in a second rating manner based on the scene distance, to determine the level of importance of the virtual element.

In some aspects, for the main control virtual character, the virtual element within the field of view range may be blocked by another virtual element. For example, when the main control virtual character observes a virtual scene from a first-person perspective, a virtual prop is blocked by a virtual wall and remains outside the wall, that is, although the virtual prop is within a field of view range of the main control virtual character, the virtual prop cannot be observed by the main control virtual character, and the virtual prop may be rated in a rating manner of a virtual element out of the field of view. In a case that the virtual element is within the field of view range and the virtual element is blocked, the importance of the virtual element is rated in the second rating manner based on the scene distance, to determine the level of importance of the virtual element.

Operation 205: Determine display performance data for the virtual element based on the level of importance of the virtual element, and perform display control on the virtual element based on the display performance data. For example, a display performance parameter for the virtual element is determined based on the level of importance. Display control of the virtual element is performed based on the display performance parameter. The display performance parameter corresponds to a presentation effect of the virtual element in the virtual scene.

The display performance data corresponds to a presentation effect of the virtual element in the virtual scene.

For example, after acquiring the level of importance of the virtual element, the server synchronizes the level of importance to each system of a game. Each system includes a plurality of pieces of performance data. The performance data includes some optimizable items (data that can be adjusted to improve performance of a processor in a computer), and the optimizable items are the display performance data that needs to be determined. The display performance data is determined according to the level of importance, so as to adjust the presentation effect of the virtual element in the virtual scene displayed on the screen of the terminal.

In an aspect, the display performance data includes at least one of the following categories:

1. The display performance data includes an element refresh rate.

The element refresh rate indicates a refresh rate of the virtual element when the virtual element is displayed in the virtual scene.

In an aspect, the element refresh rate of the virtual element is determined based on the level of importance of the virtual element. The level of importance is in a positive correlation with the element refresh rate.

In a case that the level of importance of the virtual element is higher and the importance of the virtual element to the main control virtual character is higher, the level of importance is in a positive correlation with the element refresh rate.

For example, after acquiring the level of importance of the virtual element, the server configures the element refresh rate for the virtual element according to the level of importance of the virtual element. When the level of importance of the virtual element is higher, the element refresh rate configured by the server for the virtual element is higher. When the refresh rate of the virtual element is relatively high, an interval at which the virtual element is rendered on the screen of the terminal is relatively short. Consequently, changes of the virtual element are smooth, and display smoothness of the virtual element is relatively high. When the refresh rate of the virtual element is relatively low, an interval at which the virtual element is rendered on the screen of the terminal is relatively long. Consequently, changes of the virtual element are jerky, and display smoothness of the virtual element is relatively low.

2. The display performance data includes an element synchronization rate.

In an aspect, if the virtual element is implemented as at least two sub-elements of the same type, the element synchronization rate indicates a quantity of sub-elements that are in the at least two sub-elements of the same type and that are synchronously displayed in the virtual scene.

In an aspect, the element synchronization rate corresponding to the at least two sub-elements of the same type is determined based on the level of importance of the virtual element. The level of importance is in a positive correlation with the element synchronization rate.

In a case that the level of importance of the virtual element is higher and the importance of the virtual element to the main control virtual character is higher, the level of importance is in a positive correlation with the element synchronization rate.

For example, after acquiring the level of importance of the virtual element, the server configures the element synchronization rate for the virtual element according to the level of importance of the virtual element. When the level of importance of the virtual element is higher, the element synchronization rate configured by the server for the virtual element is higher. If the virtual element is implemented as n (n is a positive integer greater than 1) sub-elements of the same type, when the element synchronization rate of the virtual element is relatively high, a synchronization rate of the n sub-elements of the same type is relatively high. For example, ten identical mobs appear close to the main control virtual character, and if a mob needs to perform a hand waving motion, a picture displaying all ten mobs waving synchronously is displayed. When the element synchronization rate of the virtual element is relatively low, the synchronization rate of the n sub-elements of the same type is relatively low. For example, ten identical mobs appear far away from the main control virtual character, and if a mob needs to perform a hand waving motion, only a picture displaying four mobs waving synchronously is displayed.

3. The display performance data includes a collision detection frequency.

The collision detection frequency indicates a frequency at which collision detection is performed on the virtual element in the virtual scene.

In an aspect, a collision detection frequency of the virtual element is determined based on the level of importance of the virtual element. The level of importance is in a positive correlation with the collision detection frequency.

In a case that the level of importance of the virtual element is higher and the importance of the virtual element to the main control virtual character is higher, the level of importance is in a positive correlation with the collision detection frequency.

For example, after acquiring the level of importance of the virtual element, the server configures the collision detection frequency for the virtual element according to the level of importance of the virtual element. When the level of importance of the virtual element is higher, the collision detection frequency configured by the server for the virtual element is higher. When the collision detection frequency of the virtual element is relatively high, realism of the virtual element in a physical layer is relatively high. For example, phenomena such as characters passing through walls or floating above a ground are less likely to occur; When the collision detection frequency of the virtual element is relatively low, realism of the virtual element in the physical layer is relatively low. For example, phenomena such as characters passing through walls or floating above a ground are more likely to occur

The foregoing examples of the display performance data are merely descriptions, and types of the display performance data and data are not limited in this aspect of this disclosure.

In conclusion, in the element display method provided in this aspect of this disclosure, the level of importance of the virtual element is determined by determining the scene distance between the first position information of the main control virtual character and the second position information of the virtual element in the virtual scene, and the field of view information corresponding to the main control virtual character, whereby the display performance data for the virtual element is determined, and display control is performed on the virtual element based on the display performance data. On one hand, differentiated display of virtual elements in a virtual scene is implemented based on levels of importance, and computing resources of a computer are properly allocated, whereby performance of a processor in the computer is optimized while normal display of the virtual scene is ensured. On the other hand, the level of importance is determined based on dual conditions of a position and a field of view, whereby a granularity of an importance criteria is improved. Accordingly, finally obtained display performance data is more accurate, and an optimization rate of the display performance of the computer is improved.

According to the method provided in this aspect of this disclosure, when the level of importance of the virtual element is rated, the dual conditions of the distance and the field of view are considered, and the virtual element is rated in different rating manners for a case in which the virtual element is in the field of view and a case in which the virtual element is out of the field of view, to differentiate rating levels of an element in the field of view and an element out of the field of view, thereby increasing reasonableness and granularity of the level of importance of the element obtained through rating. In addition, the importance of the virtual element is evaluated in a plurality of rating manners, so that the accuracy of the level of importance of the virtual element can be improved.

According to the method provided in this aspect of this disclosure, the importance of a virtual element blocked in the field of view is rated in the same manner for a virtual element out of the field of view, thereby refining the determination of rating manners for virtual elements, and further improving reasonableness of levels of importance of the elements obtained through rating. In addition, importance of the virtual element blocked in the field of view is rated in the second rating manner, which further conforms to an actual situation of a position of the virtual element.

According to the method provided in this aspect of this disclosure, after the level of importance corresponding to the virtual element is determined, at least one of the element refresh rate and the element synchronization rate of the virtual element is adjusted according to the level of importance corresponding to the virtual element. This maximizes the utilization of hardware performance to achieve a presentation effect. In an aspect, in a game, a player can selectively improve or reduce a presentation effect of an element with reference to an element level determined by an importance system, thereby affecting device performance corresponding to the game and increasing a capability of the player for controlling the device performance.

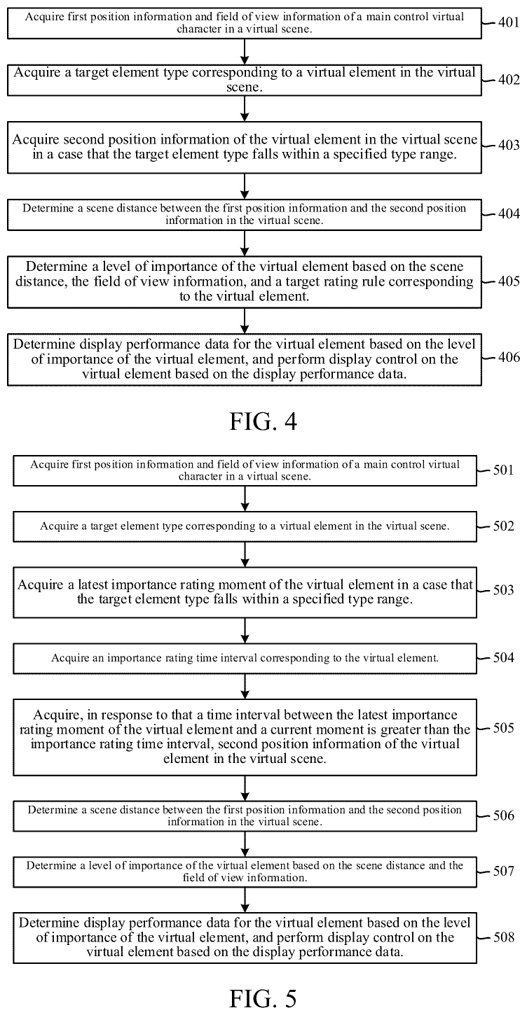

In some aspects, virtual elements of different types correspond to different rating rules. In an aspect, FIG. 4 is a flowchart of an element display method according to an aspect of this disclosure. The method may be performed by a server or a terminal, or may be jointly performed by a server and a terminal. In this aspect of this disclosure, a description is made by using an example in which the method is performed by a server. As shown in FIG. 4, the method includes the following operations.

Operation 401: Acquire first position information and field of view information of a main control virtual character in a virtual scene. For example, first position information and field of view information of a main control virtual character in a virtual scene are acquired. The field of view information indicates a field of view range of the main control virtual character within the virtual scene.

In an aspect, the first position information includes a current coordinate location of the main control virtual character in the virtual scene. For example, the virtual scene corresponds to a world coordinate system, and coordinates of the main control virtual character in the world coordinate system are the first position information.

The field of view information indicates a field of view range for observing the virtual scene from a perspective of the main control virtual character. The perspective of the main control virtual character may be a first-person perspective or a third-person perspective. This is not limited in this aspect of this disclosure. For example, a field of view range corresponding to a first virtual character controlled by a first account is represented as a range of a virtual scene that corresponds to the first account and that is displayed on a screen of a terminal, namely, a range of a window from which a player observes the virtual scene.

Operation 402: Acquire a first element type corresponding to a virtual element in the virtual scene. For example, a first element type corresponding to the virtual element in the virtual scene is acquired.

In an aspect, the virtual element may refer to a display element other than the main control virtual character in the virtual scene. The virtual element includes at least one of the following elements:

1. A character-type virtual element, including a virtual monster, a non-player character (NPC), a virtual object controlled by another account other than the main control virtual character, and the like.

2. A scene-type virtual element, may refer to an environment element forming a virtual scene, and including a natural landform element, a building element, and the like.

3. A prop-type virtual element, including a virtual vehicle, a virtual attack prop, a virtual defense prop, a virtual gemstone, a virtual gold coin, and the like.

The foregoing examples of the virtual element are merely for description, and the element type of the virtual element is not limited in this aspect of this disclosure.

For example, element types of different virtual elements are different. For example, if the virtual element is an NPC, the first element type is an NPC type; and if the virtual element is a virtual automobile, the first element type is a vehicle type.

Operation 403: Acquire second position information of the virtual element in the virtual scene in a case that the first element type falls within a specified type range. For example, the second position information of the virtual element is acquired when the first element type falls within a specified type range. The specified type range includes an element type for which importance rating is to be performed.

The specified type range includes an element type for which importance rating needs to be performed.

Alternatively, the second position information of the virtual element in the virtual scene is acquired in a case that the first element type is outside the specified type range. The specified type range includes an element type for which importance rating does not need to be performed.

For example, when the first element type corresponding to the virtual element does not exist in a target type range, it indicates that importance rating needs to be performed on the virtual element, and therefore, the virtual element is added to a rating element list. After all virtual elements in the virtual scene are filtered according to element types, the server may rate the virtual element included in the rating element list at this time, that is, the server starts to acquire the second position information of the virtual element included in the rating element list.

In an aspect, the second position information includes a current coordinate location of the virtual element in the virtual scene. For example, coordinates of the virtual element in the world coordinate system are the second position information.

In an aspect, when the first element type corresponding to the virtual element exists in the element type list, it indicates that importance rating does not need to be performed on the virtual element, and therefore, the second position information of the virtual element does not need to be acquired.

Operation 404: Determine a scene distance between the first position information and the second position information in the virtual scene. For example, a scene distance between the first position information and the second position information in the virtual scene is determined.

For example, a first coordinate of the main control virtual character in the world coordinate system is acquired, and a second coordinate of the virtual element in the world coordinate system is acquired. A coordinate distance between the first coordinate and the second coordinate is calculated. The coordinate distance is a distance between the main control virtual character and the virtual element, i.e., the scene distance.

Operation 405: Determine a level of importance of the virtual element based on the scene distance, the field of view information, and a target rating rule corresponding to the virtual element. For example, a level of importance of the virtual element is determined based on the scene distance and whether the virtual element is within or outside the field of view range that is indicated by the field of view information;

The target rating rule corresponding to the virtual element is a rule determined according to the first element type corresponding to the virtual element.

A rating rule is different from a rating manner. The rating rule is a rule determined based on an attribute (element type) of the virtual element, whereas the rating manner of the virtual element is a manner determined based on positional and field of view relationships between the virtual element and the main control virtual character.

All virtual elements follow one of at least two rating manners. On this basis, virtual elements of different types correspond to different rating rules. In an aspect, a method for determining the level of importance of the virtual element includes at least one of the following methods:

Method 1: an initial level of importance corresponding to the virtual element is determined based on the first element type; and the initial level of importance is adjusted based on the scene distance and the field of view information, to determine the level of importance of the virtual element.

In an aspect, in a case that the virtual element is within the field of view range, a first level of importance of the virtual element is determined in a first rating manner based on the scene distance; and the initial level of importance is adjusted based on the first level of importance, to determine the level of importance of the virtual element.

In an aspect, in a case that the virtual element is outside the field of view range, a second level of importance of the virtual element is determined in a second rating manner based on the scene distance; and the initial level of importance is adjusted based on the second level of importance, to determine the level of importance of the virtual element.

For example, virtual elements of different types correspond to different initial levels of importance. For example, an initial level of importance of a virtual element 1 (a character-type virtual element) is level 2 (it is assumed that level 10 is the highest level), and an initial level of importance of a virtual element 2 (a scene-type virtual element) is level 1. It is assumed that the highest level of importance is level 10, and the lowest level of importance is level 1.

In a case that the virtual element is within the field of view range, the first rating manner is used, and the importance is divided into four levels based on the distance between the virtual element and the main control virtual character: level 5 (a distance range 1), level 6 (a distance range 2), level 7 (a distance range 3), and level 8 (a distance range 4), where a value of a distance within the distance range 1>a value of a distance within the distance range 2>a value of a distance within the distance range 3>a value of a distance within the distance range 4. It is assumed that a distance between the virtual element 1 and the main control virtual character, and a distance between the virtual element 2 and the main control virtual character are both within the distance range 1, first levels of importance corresponding to the virtual element 1 and the virtual element 2 are both level 5. Therefore, a finally determined level of importance of the virtual element 1 is level 7, and a finally determined level of importance of the virtual element 2 is level 6.

In a case that the virtual element is outside the field of view range, the second rating manner is used, and the importance is divided into four levels based on the distance between the virtual element and the main control virtual character: level 1 (a distance range 5), level 2 (a distance range 6), level 3 (a distance range 7), and level 4 (a distance range 8), where a value of a distance within the distance range 5>a value of a distance within the distance range 6>a value of a distance within the distance range 7>a value of a distance within the distance range 8. It is assumed that the distance between the virtual element 1 and the main control virtual character falls within the distance range 7, the second level of importance corresponding to the virtual element 1 is level 3, and it is assumed that the distance between the virtual element 2 and the main control virtual character falls within the distance range 8, the second level of importance corresponding to the virtual element 2 is level 4. Therefore, a finally determined level of importance of the virtual element 1 is level 5, and a finally determined level of importance of the virtual element 2 is level 5.

Method 2: an importance adjustment weight corresponding to the virtual element is determined based on the first element type; and the level of importance of the virtual element is determined based on the scene distance and the field of view information according to the importance adjustment weight.

In an aspect, in a case that the virtual element is within the field of view range, a first level of importance of the virtual element is determined in a first rating manner based on the scene distance; and the first level of importance is weighted based on the importance adjustment weight, and a weighted first level of importance is determined as the level of importance of the virtual element.

In an aspect, in a case that the virtual element is outside the field of view range, a second level of importance of the virtual element is determined in a second rating manner based on the scene distance; and the second level of importance is weighted based on the importance adjustment weight, and a weighted second level of importance is determined as the level of importance of the virtual element.

For an example of a method for determining the first level of importance, reference can be made to the method for determining the first level of importance in the foregoing method 1, and for an example of a method for determining the second level of importance, reference can be made to the method for determining the second level of importance in the foregoing method 1. Details are not described herein again.

In an aspect, virtual elements of different types correspond to different importance adjustment weights, and an importance adjustment weight of a character-type virtual element is greater than an importance adjustment weight of a scene-type virtual element.

Method 3: an importance level comparison table corresponding to the virtual element is determined based on the first element type; and the level of importance corresponding to the virtual element is determined according to the importance level comparison table based on the scene distance and the field of view information.

Virtual elements of different types correspond to different importance level comparison tables. For a virtual element of a specified type, an importance level comparison table is a table determined based on the virtual element of such a type.

For example, the importance level comparison table is as the following Table 1:

TABLE 1

| | Distance range | Distance range | Distance range |
|---|---|---|---|
| | (0, 10) | (10, 30) | (30, 70) |
| Within a field | Level 10 | Level 7 | Level 5 |
| of view range | | | |
| Outside a field | Level 4 | Level 3 | Level 2 |
| of view range | | | |

The foregoing distances in the importance level comparison table are merely descriptions, and are not limited in this aspect of this disclosure.

Operation 406: Determine display performance data for the virtual element based on the level of importance of the virtual element, and perform display control on the virtual element based on the display performance data. For example, a display performance parameter for the virtual element is determined based on the level of importance. Display control of the virtual element is performed based on the display performance parameter. The display performance parameter corresponds to a presentation effect of the virtual element in the virtual scene.

The display performance data corresponds to a presentation effect of the virtual element in the virtual scene.

For example, after acquiring the level of importance of the virtual element, the server synchronizes the level of importance to each system of a game. Each system includes a plurality of pieces of performance data. The performance data includes some optimizable items (data that can be adjusted to improve performance of a processor in a computer), and the optimizable items are the display performance data that needs to be determined. The display performance data is determined according to the level of importance, so as to adjust the presentation effect of the virtual element in the virtual scene displayed on the screen of the terminal.

In conclusion, in the element display method provided in this aspect of this disclosure, the level of importance of the virtual element is determined by determining the scene distance between the first position information of the main control virtual character and the second position information of the virtual element in the virtual scene, and the field of view information corresponding to the main control virtual character, whereby the display performance data for the virtual element is determined, and display control is performed on the virtual element based on the display performance data. On one hand, differentiated display of virtual elements in a virtual scene is implemented based on levels of importance, and computing resources of a computer are properly allocated, whereby performance of a processor in the computer is optimized while normal display of the virtual scene is ensured. On the other hand, the level of importance is determined based on dual conditions of a position and a field of view, whereby a granularity of an importance criteria is improved. Accordingly, finally obtained display performance data is more accurate, and an optimization rate of the display performance of the computer is improved.

According to the method provided in this aspect of this disclosure, the virtual elements are filtered based on the element types of the virtual elements, to determine a virtual element for which importance rating needs to be performed. Therefore, virtual elements participating in the importance rating are reduced, and a data volume processed by the computer is reduced. In addition, a manner of performing initial filtering on the virtual elements based on the element types can improve accuracy of subsequent rating for levels of importance of the virtual elements.

According to the method provided in this aspect of this disclosure, the virtual elements are endowed with different initial levels of importance based on the element types of the virtual elements, whereby level adjustment can be performed based on the different initial levels of importance, and accuracy of the importance rating is improved.

In some aspects, before the importance of the virtual element is rated, whether the virtual element satisfies a rating criteria is required to be determined. FIG. 5 is a flowchart of an element display method according to an aspect of this disclosure. The method may be performed by a server or a terminal, or may be jointly performed by a server and a terminal. In this aspect of this disclosure, a description is made by using an example in which the method is performed by a server. As shown in FIG. 5, the method includes the following operations.

Operation 501: Acquire first position information and field of view information of a main control virtual character in a virtual scene. For example, first position information and field of view information of a main control virtual character in a virtual scene are acquired. The field of view information indicates a field of view range of the main control virtual character within the virtual scene.

In an aspect, the first position information includes a current coordinate location of the main control virtual character in the virtual scene. For example, the virtual scene corresponds to a world coordinate system, and coordinates of the main control virtual character in the world coordinate system are the first position information.

The field of view information indicates a field of view range for observing the virtual scene from a perspective of the main control virtual character. The perspective of the main control virtual character may be a first-person perspective or a third-person perspective. This is not limited in this aspect of this disclosure. For example, a field of view range corresponding to a first virtual character controlled by a first account is represented as a range of a virtual scene that corresponds to the first account and that is displayed on a screen of a terminal, namely, a range of a window from which a player observes the virtual scene.

Operation 502: Acquire a first element type corresponding to a virtual element in the virtual scene. For example, a first element type corresponding to the virtual element in the virtual scene is acquired.

In an aspect, the virtual element may refer to a display element other than the main control virtual character in the virtual scene. The virtual element includes at least one of the following elements:

1. A character-type virtual element, including a virtual monster, a non-player character (NPC), a virtual object controlled by another account other than the main control virtual character, and the like.

2. A scene-type virtual element, may referring to an environment element forming a virtual scene, and including a natural landform element, a building element, and the like.

3. A prop-type virtual element, including a virtual vehicle, a virtual attack prop, a virtual defense prop, a virtual gemstone, a virtual gold coin, and the like.

The foregoing examples of the virtual element are merely for description, and the element type of the virtual element is not limited in this aspect of this disclosure.

For example, element types of different virtual elements are different. For example, if the virtual element is an NPC, the first element type is an NPC type; and if the virtual element is a virtual automobile, the first element type is a vehicle type.

Operation 503: Acquire a latest importance rating moment of the virtual element in a case that the first element type falls within a specified type range. For example, a latest importance rating moment of the virtual element is acquired.

The specified type range includes an element type for which importance rating needs to be performed.

For example, when the first element type falls within the specified type range, it indicates that the importance rating needs to be performed on the virtual element. In this case, the latest importance rating moment of the virtual element is acquired, that is, a previous moment at which the level of importance is determined.

Operation 504: Acquire an importance rating time interval corresponding to the virtual element. For example, an importance rating time interval corresponding to the virtual element is acquired.

For example, each virtual element corresponds to an importance rating time interval, and the importance rating time interval indicates frequency of importance rating of the virtual element.

In some aspects, various virtual elements correspond to a same importance rating time interval. That is, rating frequencies corresponding to all virtual elements for which importance rating needs to be performed in the virtual scene are the same.

Alternatively, in some aspects, the importance rating time interval corresponding to the virtual element is determined according to the first element type corresponding to the virtual element.

In an aspect, the importance rating time interval corresponding to the virtual element is determined as a first time interval in a case that the virtual element is a character-type virtual element; and the importance rating time interval corresponding to the virtual element is determined as a second time interval when the virtual element is a scene-type virtual element.

The first time interval is less than the second time interval.

That is, the rating frequency of the character-type virtual element is relatively high, and the rating frequency of the scene-type virtual element is relatively low.

Operation 505: Acquire, in response to that a time interval between the latest importance rating moment of the virtual element and a current moment is greater than the importance rating time interval, second position information of the virtual element in the virtual scene. For example, the second position information of the virtual element is acquired when a time interval between the latest importance rating moment of the virtual element and a current moment is greater than the importance rating time interval.

For example, the time interval between the latest importance rating moment of the virtual element and the current moment is calculated, it is assumed that the time interval is 0.2 seconds, which is less than the importance rating time interval of 0.8 seconds, then importance rating does not need to be performed at the current moment, that is, the second position information of the virtual element in the virtual scene does not need to be acquired.

It is assumed that the time interval is 1 second, which is greater than the importance rating time interval of 0.8 seconds, then importance rating needs to be performed at the current moment, that is, the second position information of the virtual element in the virtual scene is acquired.

Operation 506: Determine a scene distance between the first position information and the second position information in the virtual scene. For example, a scene distance between the first position information and the second position information in the virtual scene is determined.

For example, a first coordinate of the main control virtual character in the world coordinate system is acquired, and a second coordinate of the virtual element in the world coordinate system is acquired. A coordinate distance between the first coordinate and the second coordinate is calculated. The coordinate distance is a distance between the main control virtual character and the virtual element, i.e., the scene distance.

Operation 507: Determine a level of importance of the virtual element based on the scene distance and the field of view information. For example, a level of importance of the virtual element is determined based on the scene distance and whether the virtual element is within or outside the field of view range that is indicated by the field of view information.

The level of importance of the virtual element is importance of the virtual element to the main control virtual character in a current virtual scene. In this aspect of this disclosure, the level of importance of the virtual element is determined based on dual conditions of the scene distance and the field of view information.

Operation 508: Determine display performance data for the virtual element based on the level of importance of the virtual element, and perform display control on the virtual element based on the display performance data. For example, a display performance parameter for the virtual element is determined based on the level of importance. Display control of the virtual element is performed based on the display performance parameter. The display performance parameter corresponds to a presentation effect of the virtual element in the virtual scene.

The display performance data corresponds to a presentation effect of the virtual element in the virtual scene.

For example, after acquiring the level of importance of the virtual element, the server synchronizes the level of importance to each system of a game. Each system includes a plurality of pieces of performance data. The performance data includes some optimizable items (data that can be adjusted to improve performance of a processor in a computer), and the optimizable items are the display performance data that needs to be determined. The display performance data is determined according to the level of importance, so as to adjust the presentation effect of the virtual element in the virtual scene displayed on the screen of the terminal.

In some aspects, if the virtual element is outside the field of view range of the main control virtual character at a first moment, a level of importance of the virtual element that is determined in a second rating manner is determined as a target level of importance. When the virtual element appears within the field of view range of the main control virtual character at a second moment (an interval between the second moment and the first moment is small, and the second moment occurs sequentially after the first moment), if the importance rating moment of the virtual element is not reached at the second moment, the system still determines the display performance data for the virtual element according to the target level of importance determined previously.

In conclusion, in the element display method provided in this aspect of this disclosure, the level of importance of the virtual element is determined by determining the scene distance between the first position information of the main control virtual character and the second position information of the virtual element in the virtual scene, and the field of view information corresponding to the main control virtual character, whereby the display performance data for the virtual element is determined, and display control is performed on the virtual element based on the display performance data. On one hand, differentiated display of virtual elements in a virtual scene is implemented based on levels of importance, and computing resources of a computer are properly allocated, whereby performance of a processor in the computer is optimized while normal display of the virtual scene is ensured. On the other hand, the level of importance is determined based on dual conditions of a position and a field of view, whereby a granularity of an importance criteria is improved. Accordingly, finally obtained display performance data is more accurate, and an optimization rate of the display performance of the computer is improved.

In this aspect, according to virtual elements of different types, the importance rating time intervals respectively corresponding to the different virtual elements are determined, and therefore the importance rating time interval of each virtual element meets a rating requirement. Accordingly, an unnecessary rating process is avoided and data overhead of the computer is reduced.

According to the method provided in this aspect of this disclosure, importance rating frequencies of virtual elements of different types are different. For example, a rating frequency of a character-type virtual element with relatively high importance is relatively high, and a rating frequency of a character-type virtual element with relatively low importance is relatively low. A data processing resource of the computer is properly allocated, thereby improving data processing efficiency of the computer in an importance rating process.

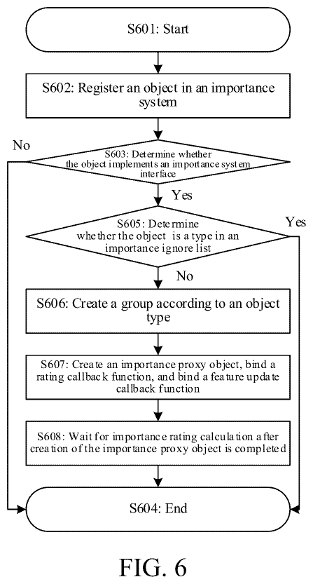

For example, a flowchart of registration for importance rating provided in this disclosure is described below. As shown in FIG. 6, the flow includes the following operations:

S601: Start.

In an aspect, a description is made by using an example in which a development platform for a specified application is implemented as a virtual engine. When a player logs in to the specified application in a terminal with a first account corresponding to a main control virtual character, an importance rating event of all virtual elements except the main control virtual character in a virtual scene is triggered while the main control virtual character enters the virtual scene, that is, from the perspective of a program, an importance system registration event of an object corresponding to the virtual element is triggered.

S602: Register an object in an importance system.

For example, for a specified virtual element, after receiving a registration event of an object corresponding to the specified virtual element, an importance system in a server accepts the object, to determine whether the specified virtual element satisfies an importance rating criteria.

S603: Determine whether the object implements an importance system interface.

For example, first, the importance system determines whether the object corresponding to the specified virtual element implements the importance system interface. For example, whether the object implements an importance interface INGRCSignificanceInterface function is checked, that is, whether the object corresponding to the specified virtual element declares a method INGRCSignificanceInterface( ).

S604: If the object does not implement the importance system interface, the process ends.

For example, if the object corresponding to the specified virtual element does not implement the importance interface INGRCSignificanceInterface function, it is determined that the specified virtual element does not satisfy the importance rating criteria, and an importance rating event of the specified virtual element is ended.

S605: Determine whether the object is a type in an importance ignore list if the object implements the importance system interface.

For example, if the object corresponding to the specified virtual element implements the importance system interface, whether a type corresponding to the specified virtual element is the type in the importance ignore list continues to be determined. For example, whether a type (obtained through a GetClass( ) system interface) corresponding to the object is included in an IgnoreList (the importance ignore list) of SignificanceSetting is determined.

An element type included in the importance ignore list is an element type that is ignored when importance rating is performed, that is, an element type for which importance rating does not need to be performed.

S604: If the object is the type in the importance ignore list, the process ends.

For example, if the type corresponding to the specified virtual element is the type in the importance ignore list, it indicates that the specified virtual element is an element for which importance rating does not need to be performed, and the importance rating of the specified virtual element is ended.

S606: create a group according to an object type if the object is not the type in the importance ignore list.

For example, if the type corresponding to the specified virtual element is not the type in the importance ignore list, it indicates that the specified virtual element is an element for which importance rating needs to be performed, that is, the object corresponding to the specified virtual element is successfully registered in the importance system.

Groups are created for objects that are successfully registered in the importance system, and objects in different groups correspond to different importance rating frequencies. For example, an importance rating frequency of an object corresponding to a character-type virtual element is high, and an importance rating frequency of an object corresponding to a scene-type virtual element is low. After grouping is completed, multithreaded importance rating calculation is separately performed according to different categories.

For example, whether the object type is a Character type or a SceneItem type is determined, and different calculation groups Tag are created according to different types. The group Tag is equal to ENGRCSignificanceType_Character (a group Tag of a character-type virtual element) or ENGRCSignificanceType_Item (a group Tag of a scene-type virtual element).

S607: Create an importance proxy object, bind a rating callback function, and bind a feature update callback function.

For example, after the group is created, a proxy object of a real object is created, and a proxy object Tag is set at the same time. The proxy object Tag is an object type (Character or SceneItem). Moreover, for the proxy object, an importance rating function OnSignificanceFunction( ) of the proxy object is bound, and a feature update function OnPostSignificanceFunction( ) of the proxy object is bound.

S608: Wait for importance rating calculation after creation of the importance proxy object is completed.

For example, after creation and initialization of the proxy object are completed, importance rating creation may be waited for, to complete object registration.

S604: End.

For example, after the object registration is completed, the process is ended.

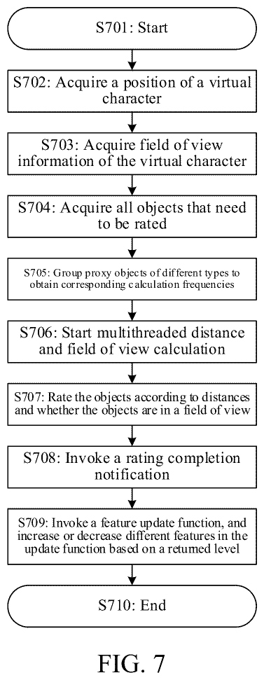

For example, FIG. 7 is a flowchart of importance rating according to an aspect of this disclosure. As shown in FIG. 7, the flow includes the following operations.

S701: Start.

That is, an importance rating process starts.

S702: Acquire a position of a virtual character.

For example, transform information, including a position, rotation, and zoom, corresponding to the virtual character is acquired through a system interface provided in a virtual engine.

S703: Acquire field of view information of the virtual character.

For example, field of view information corresponding to ViewPort (namely, a display area of a screen of a terminal, that is, a visual window of the virtual character) in Controller (that is, a control module corresponding to the virtual character) is acquired through the system interface provided in the virtual engine.

S704: Acquire all objects that need to be rated.

For example, all objects ManagedObjects (a proxy object data set) that need to be rated are acquired, that is, a set of proxy objects determined according to operations S601 to S608.

S705: Group proxy objects of different types to obtain corresponding calculation frequencies.

For example, after S607, each proxy object in ManagedObjects (the proxy object data set) has a corresponding proxy object Tag, an object type corresponding to the proxy object Tag is the group of the proxy object, and the importance calculation frequency of the proxy object is determined according to different groups.

For example, all proxy objects ManagedObjects are traversed to obtain a last calculation time LastUpdateTime of a single object, and a calculation time interval TagCheck Time corresponding to a single proxy object Tag is obtained based on an attribute of the proxy object Tag and TagCheck TimeMap (configured for storing importance calculation frequencies of proxy objects in different groups, different proxy object Tag indicating different groups) in a global configuration SignificanceSetting. In an aspect, optimal TagCheckTime corresponding to a Character type object is equal to 0.1 s, and optimal TagCheckTime corresponding to a SceneItem type object is equal to 0.8 s. Whether a current time CurrentTimeSeconds minus LastUpdateTime (the last importance calculation time of the proxy object) is greater than TagCheckTime is calculated. If the current time CurrentTimeSeconds minus LastUpdateTime is greater than TagCheckTime, the proxy object is added to a calculation data set ObjArray (that is, a proxy object data set satisfying an importance calculation criteria), otherwise, the proxy object is ignored.

S706: Start multithreaded distance and field of view calculation.

For example, multithreaded calculation is started, distances between all objects in ObjArray and the virtual character are calculated, whether the object is in the field of view of a player is determined by calculating an intersection between the field of view of the player and the object Bound by an IntersectBox method, and then calculation and updating of a field of view state is completed by excluding an object blocked in the field of view based on WasRecentlyRendered( ) of the object.

S707: Rate objects according to the distances and whether the objects are in the field of view.

An object that is blocked in the field of view belongs to an object out of the field of view. A level of importance is extracted from SignificanceCharacterConfig (a configuration for level of importance of character type) and SignificanceItemConfig (a configuration for level of importance of scene type) in SignificanceSetting based on the calculated distance value and the field of view state, and a bound importance rating function OnSignificanceFunction( ) is invoked, to bind the level of importance to the proxy object.

S708: Invoke a rating completion notification.

For example, the rating completion notification is invoked, and the importance rating completion notification is transmitted to a plurality of functional systems. Each functional system includes an optimizable system parameter that can be adjusted according to the level of importance.

S709: Invoke a feature update function, and increase or decrease different features in the update function based on a returned level.

For example, after receiving the rating completion notification, the plurality of functional systems invoke a bound feature update function OnPostSignificanceFunction ( ) to update a latest level of importance to each functional system. Different functional systems may increase or decrease features in the update function based on a returned level of importance. For example, a display refresh rate system increases or decreases a display refresh rate of a corresponding virtual element according to the level of importance.

S710: End.

For example, importance rating ends.

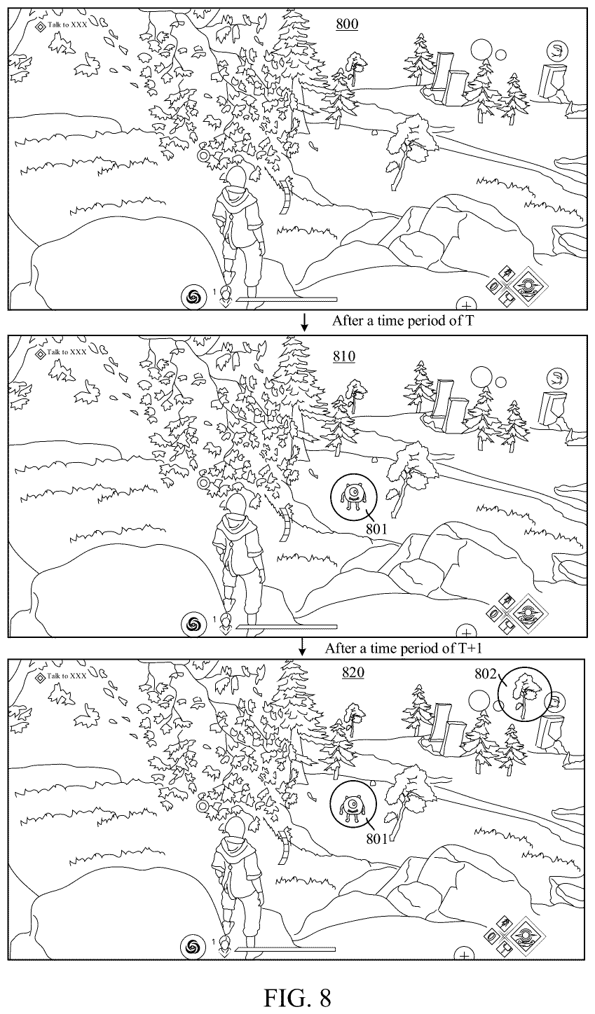

In an aspect, after importance rating is performed, the level of importance of each virtual element in the virtual scene may be transmitted to a refresh rate configuration system. FIG. 8 is a schematic diagram of a presentation of a virtual element subjected to rating by an importance system. As shown in FIG. 8,
it is determined that a level of importance of a virtual element 801 is greater than a level of importance of a virtual element 802, and refresh rates of the virtual element 801 and the virtual element 802 are set based on the levels of importance respectively corresponding to the virtual element 801 and the virtual element 802.

In a scenario 800, the virtual element 801 and the virtual element 802 disappear at the same time. After a time period of T, the virtual element 801 is displayed in a scenario 810, and after a time period of T+1, the virtual element 802 is displayed in a scenario 820.

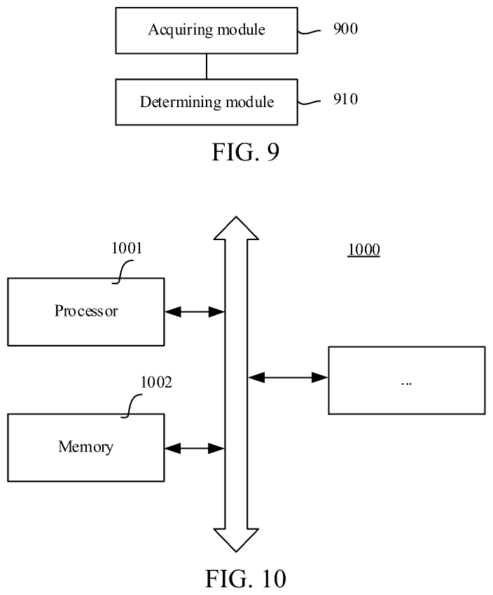

FIG. 9 is a structural block diagram of an element display apparatus according to an aspect of this disclosure. The apparatus includes the following modules:
an acquiring module 900, configured to acquire first position information and field of view information of a main control virtual character in a virtual scene, the field of view information indicating a field of view range for observing the virtual scene from a perspective of the main control virtual character, and
acquire second position information of a virtual element in the virtual scene; and
a determining module 910, configured to determine a scene distance between the first position information and the second position information in the virtual scene,
determine a level of importance of the virtual element based on the scene distance and the field of view information, the level of importance of the virtual element being rated in at least one of at least two rating manners based on whether the virtual element is within or outside the field of view range, and
determine display performance data for the virtual element based on the level of importance of the virtual element, and perform display control on the virtual element based on the display performance data, the display performance data corresponding to a presentation effect of the virtual element in the virtual scene.

In some aspects, the determining module 910 is further configured to: in a case that the virtual element is within the field of view range, rate importance of the virtual element in a first rating manner based on the scene distance, and determine the level of importance of the virtual element, and in a case that the virtual element is outside the field of view range, rate importance of the virtual element in a second rating manner based on the scene distance, to determine the level of importance of the virtual element. Distance ranges respectively corresponding to the first rating manner and the second rating manner are determined based on a distance between the virtual element and the main control virtual character, and a distance span corresponding to the distance range for the level of importance in the first rating manner is greater than a distance span corresponding to the distance range for the level of importance in the second rating manner.

In some aspects, the determining module 910 is further configured to: in a case that the virtual element is within the field of view range and the virtual element is blocked, rate the importance of the virtual element in the second rating manner based on the scene distance, to determine the level of importance of the virtual element.

In some aspects, the display performance data includes an element refresh rate, and the element refresh rate indicates a refresh rate of the virtual element when the virtual element is displayed in the virtual scene. The determining module 910 is further configured to determine the element refresh rate of the virtual element based on the level of importance of the virtual element, the level of importance being in a positive correlation with the element refresh rate.

In some aspects, the virtual element is implemented as at least two sub-elements of the same type, and the element synchronization rate indicates a quantity of sub-elements that are in the at least two sub-elements of the same type and that are synchronously displayed in the virtual scene; and the determining module 910 is further configured to determine, based on the level of importance of the virtual element, an element synchronization rate corresponding to the at least two sub-elements of the same type, the level of importance being in a positive correlation with the element synchronization rate.

In some aspects, the acquiring module 900 is further configured to acquire a first element type corresponding to the virtual element in the virtual scene, acquire the second position information of the virtual element in the virtual scene in a case that the first element type falls within a specified type range, the specified type range including an element type for which importance rating needs to be performed.

In some aspects, the acquiring module 900 is further configured to acquire a latest importance rating moment of the virtual element in a case that the first element type falls within the specified type range, acquire an importance rating time interval corresponding to the virtual element, and acquire, in response to that a time interval between the latest importance rating moment of the virtual element and a current moment is greater than the importance rating time interval, the second position information of the virtual element in the virtual scene.

In some aspects, the acquiring module 900 is further configured to determine the importance rating time interval corresponding to the virtual element as a first time interval in a case that the virtual element is a character-type virtual element, and determine the importance rating time interval corresponding to the virtual element as a second time interval in a case that the virtual element is a scene-type virtual element. The first time interval is less than the second time interval.

In some aspects, the determining module 910 is further configured to determine, based on the first element type, an initial level of importance corresponding to the virtual element, and adjust the initial level of importance based on the scene distance and the field of view information, to determine the level of importance of the virtual element.

In conclusion, according to the element display apparatus provided in this aspect of this disclosure, the level of importance of the virtual element is determined by determining the scene distance between the first position information of the main control virtual character and the second position information of the virtual element in the virtual scene, and the field of view information corresponding to the main control virtual character, whereby the display performance data for the virtual element is determined, and display control is performed on the virtual element based on the display performance data. On one hand, differentiated display of virtual elements in a virtual scene is implemented based on levels of importance, and computing resources of a computer are properly allocated, whereby performance of a processor in the computer is optimized while normal display of the virtual scene is ensured. On the other hand, the level of importance is determined based on dual conditions of a position and a field of view, whereby a granularity of an importance criteria is improved. Accordingly, finally obtained display performance data is more accurate, and an optimization rate of the display performance of the computer is improved.

In addition, the element display apparatus provided in the foregoing aspects is illustrated with an example of division of the foregoing functional modules. In actual application, the functions may be allocated to and completed by different functional modules according to requirements, that is, an internal structure of a device is divided into different functional modules, to implement all or some of the functions described above. In addition, the element display apparatus provided in the foregoing aspects and the element display method aspects belong to the same concept. For details of an example implementation process, reference can be made to the method aspects. Details are not described herein again.

FIG. 10 is a structural block diagram of a computer device 1000 according to an aspect of this disclosure. The computer device 1000 may be: a smartphone, a tablet computer, a moving picture experts group audio layer III (MP3) player, a moving picture experts group audio layer IV (MP4) player, a laptop or a desktop computer. The computer device 1000 may alternatively be referred to as another name such as a user device, a portable computer device, a laptop computer device, or a desktop computer device.

The computer device 1000 includes: processing circuitry (for example, a processor 1001) and a memory 1002.

Processing circuitry, such as the processor 1001, may include one or more processing cores such as a 4-core processor or an 8-core processor. The processor 1001 may be implemented in at least one of the following hardware forms: a digital signal processor (DSP), a field-programmable gate array (FPGA), and a programmable logic array (PLA). The processor 1001 may alternatively include a main processor and a coprocessor. The main processor is a processor configured to process data in an awake state, and is also referred to as a central processing unit (CPU). The coprocessor is a low-power-consumption processor configured to process data in a standby state. In some aspects, the processor 1001 may be integrated with a graphics processing unit (GPU). The GPU is configured to render and draw content that needs to be displayed on a display. In some aspects, the processor 1001 further includes an artificial intelligence (AI) processor. The AI processor is configured to process a computing operation related to machine learning.

The memory 1002 may include one or more computer-readable storage media. The computer-readable storage medium may be non-transient. The memory 1002 may further include a high-speed random-access memory and a nonvolatile memory, for example, one or more disk storage devices or flash storage devices. In some aspects, a non-transitory computer-readable storage medium in the memory 1002 is configured to store at least one instruction, and the at least one instruction is configured to be executed by the processor 1001 to implement the element display method provided in the method aspects of this disclosure.

For example, the computer device 1000 further includes another component. Those skilled in the art may understand that the structure shown in FIG. 10 does not constitute a limitation to the computer device 1000, and the computer device 1000 may include more or fewer components than those shown in the figure, or some components may be combined, or a different component deployment may be used.

Those of ordinary skill in the art may understand that all or some of the operations of the methods in the aspects may be implemented by a program instructing relevant hardware. The program may be stored in a computer-readable storage medium such as a non-transitory computer-readable storage medium. The computer-readable storage medium may be the computer-readable storage medium included in the memory in the foregoing aspect, or may exist alone without being installed into the computer device. The computer-readable storage medium has at least one instruction, at least one program, a code set, or an instruction set stored therein, and the at least one instruction, the at least one program, the code set, or the instruction set are loaded and executed by a processor to implement the element display method according to any one of the foregoing aspects of this disclosure.

In an aspect, the computer-readable storage medium includes: a read only memory (ROM), a random-access memory (RAM), a solid-state drive (SSD), an optical disc, or the like. The RAM may include a resistance random-access memory (ReRAM) and a dynamic random-access memory (DRAM). The sequence numbers of the foregoing aspects of this disclosure are merely for description purpose and do not imply any preference among the aspects.

What is claimed is:

1. An element display method, comprising:
acquiring first position information and field of view information of a main control virtual character in a virtual scene, the field of view information indicating a field of view range of the main control virtual character within the virtual scene;
acquiring second position information of a virtual element in the virtual scene;
determining a scene distance between the first position information and the second position information in the virtual scene;
determining a level of importance of the virtual element based on the scene distance and whether the virtual element is within or outside the field of view range that is indicated by the field of view information;
determining a display performance parameter for the virtual element based on the level of importance; and
performing display control of the virtual element based on the display performance parameter, the display performance parameter corresponding to a presentation effect of the virtual element in the virtual scene.

2. The method according to claim 1, wherein the determining the level of importance of the virtual element comprises:
determining the level of importance of the virtual element based on the scene distance and a first set of distance ranges when the virtual element is within the field of view range; and
determining the level of importance of the virtual element based on the scene distance and a second set of distance ranges when the virtual element is outside the field of view range, wherein a total range of the first set of distance ranges is greater than a total range of the second set of distance ranges.

3. The method according to claim 2, further comprising:
when the virtual element is within the field of view range and the virtual element is blocked from view, determining the level of importance of the virtual element based on the scene distance and the second set of distance ranges.

4. The method according to claim 1, wherein the display performance parameter includes an element refresh rate indicating a refresh rate of the virtual element when the virtual element is displayed in the virtual scene, and
the determining the display performance parameter comprises:
determining the element refresh rate of the virtual element based on the level of importance of the virtual element, the level of importance being positively correlated with the element refresh rate.

5. The method according to claim 1, wherein the virtual element is implemented as at least two sub-elements of a same type, the display performance parameter includes an element synchronization rate indicating a quantity of the at least two sub-elements that are synchronously displayed in the virtual scene; and
the determining the display performance parameter comprises:
determining the element synchronization rate based on the level of importance of the virtual element, the level of importance being positively correlated with the element synchronization rate.

6. The method according to claim 1, wherein the acquiring the second position information of the virtual element comprises:
acquiring a first element type corresponding to the virtual element in the virtual scene; and
acquiring the second position information of the virtual element when the first element type falls within a specified type range, the specified type range including an element type for which importance rating is to be performed.

7. The method according to claim 6, wherein the acquiring the second position information of the virtual element comprises:
acquiring a latest importance rating moment of the virtual element;
acquiring an importance rating time interval corresponding to the virtual element; and
acquiring the second position information of the virtual element when a time interval between the latest importance rating moment of the virtual element and a current moment is greater than the importance rating time interval.

8. The method according to claim 7, wherein the acquiring the importance rating time interval corresponding to the virtual element comprises:
determining the importance rating time interval as a first time interval when the virtual element is a character-type virtual element; and
determining the importance rating time interval as a second time interval when the virtual element is a scene-type virtual element, wherein the first time interval is less than the second time interval.

9. The method according to claim 6, wherein the determining the level of importance of the virtual element comprises:
determining, based on the first element type, an initial level of importance corresponding to the virtual element; and
adjusting the initial level of importance based on the scene distance and the field of view information to determine the level of importance of the virtual element.

10. An information processing apparatus, comprising:
processing circuitry configured to:
acquire first position information and field of view information of a main control virtual character in a virtual scene, the field of view information indicating a field of view range of the main control virtual character within the virtual scene;
acquire second position information of a virtual element in the virtual scene;
determine a scene distance between the first position information and the second position information in the virtual scene;
determine a level of importance of the virtual element based on the scene distance and whether the virtual element is within or outside the field of view range that is indicated by the field of view information;
determine a display performance parameter for the virtual element based on the level of importance; and
perform display control of the virtual element based on the display performance parameter, the display performance parameter corresponding to a presentation effect of the virtual element in the virtual scene.

11. The apparatus according to claim 10, wherein the processing circuitry is configured to:
determine the level of importance of the virtual element based on the scene distance and a first set of distance ranges when the virtual element is within the field of view range; and
determine the level of importance of the virtual element based on the scene distance and a second set of distance ranges when the virtual element is outside the field of view range, wherein a total range of the first set of distance ranges is greater than a total range of the second set of distance ranges.

12. The apparatus according to claim 11, wherein the processing circuitry is configured to:
when the virtual element is within the field of view range and the virtual element is blocked from view, determine the level of importance of the virtual element based on the scene distance and the second set of distance ranges.

13. The apparatus according to claim 10, wherein the display performance parameter includes an element refresh rate indicating a refresh rate of the virtual element when the virtual element is displayed in the virtual scene, and
the processing circuitry is further configured to:
determine the element refresh rate of the virtual element based on the level of importance of the virtual element, the level of importance being positively correlated with the element refresh rate.

14. The apparatus according to claim 10, wherein the virtual element is implemented as at least two sub-elements of a same type, the display performance parameter includes an element synchronization rate indicating a quantity of the at least two sub-elements that are synchronously displayed in the virtual scene; and
the processing circuitry is further configured to:
determine the element synchronization rate based on the level of importance of the virtual element, the level of importance being positively correlated with the element synchronization rate.

15. The apparatus according to claim 10, wherein the processing circuitry is configured to:
acquire a first element type corresponding to the virtual element in the virtual scene; and
acquire the second position information of the virtual element when the first element type falls within a specified type range, the specified type range including an element type for which importance rating is to be performed.

16. The apparatus according to claim 15, wherein the processing circuitry is configured to:
acquire a latest importance rating moment of the virtual element;
acquire an importance rating time interval corresponding to the virtual element; and
acquire the second position information of the virtual element when a time interval between the latest importance rating moment of the virtual element and a current moment is greater than the importance rating time interval.

17. The apparatus according to claim 16, wherein the processing circuitry is configured to:
determine the importance rating time interval as a first time interval when the virtual element is a character-type virtual element; and
determine the importance rating time interval as a second time interval when the virtual element is a scene-type virtual element, wherein the first time interval is less than the second time interval.

18. The apparatus according to claim 15, wherein the processing circuitry is configured to:
determine, based on the first element type, an initial level of importance corresponding to the virtual element; and
adjust the initial level of importance based on the scene distance and the field of view information to determine the level of importance of the virtual element.

19. A non-transitory computer-readable storage medium storing instructions which, when executed by a processor, cause the processor to perform:
acquiring first position information and field of view information of a main control virtual character in a virtual scene, the field of view information indicating a field of view range of the main control virtual character within the virtual scene;
acquiring second position information of a virtual element in the virtual scene;
determining a scene distance between the first position information and the second position information in the virtual scene;
determining a level of importance of the virtual element based on the scene distance and whether the virtual element is within or outside the field of view range that is indicated by the field of view information;
determining a display performance parameter for the virtual element based on the level of importance; and
performing display control of the virtual element based on the display performance parameter, the display performance parameter corresponding to a presentation effect of the virtual element in the virtual scene.

20. The non-transitory computer-readable storage medium according to claim 19, wherein the determining the level of importance of the virtual element comprises:
determining the level of importance of the virtual element based on the scene distance and a first set of distance ranges when the virtual element is within the field of view range; and
determining the level of importance of the virtual element based on the scene distance and a second set of distance ranges when the virtual element is outside the field of view range, wherein a total range of the first set of distance ranges is greater than a total range of the second set of distance ranges.
